(19) United States
(12) Patent Application Publication
(10) Pub. No.: US 2025/0151763 A1
(43) Pub. Date: May 15, 2025

(54) METHOD FOR MANUFACTURING BIBIM RICE BURGER

(71) Applicant: LOTTE GRS Co., Ltd., Seoul (KR)

(72) Inventors: Kiyeong JEONG, Seoul (KR); Bonkou KOO, Seoul (KR); Yoonjoo LEE, Seoul (KR); Taewoo KIM, Seoul (KR); Gyeonghweon LEE, Seoul (KR)

(21) Appl. No.: 18/944,923

(22) Filed: Nov. 12, 2024

(30) Foreign Application Priority Data
Nov. 15, 2023 (KR) 10-2023-0157882

(51) Int. Cl. A23L 7/10; A23L 3/36; A23L 19/00; A23L 27/12; A23P 30/10

(52) U.S. Cl. CPC A23L 7/1975; A23B 2/80; A23L 19/03; A23L 27/12; A23P 30/10

(57) ABSTRACT

Disclosed is a method for manufacturing a bibim rice burger, more particularly, a method for manufacturing a bibim rice burger, including: a bun producing process; a sauce producing process; and a burger assembling process, for a bibim rice burger which replaces existing burger buns with rice buns, and has a bibimbap dish shape, and in which lots of minor ingredients such as vegetables, eggs, and meat patty are mixed with hot pepper paste sauce.

### CROSS REFERENCE TO RELATED APPLICATION

The present application claims priority to Korea Patent Application No. 10-2023-0157882, filed Nov. 15, 2023, the entire contents of which is incorporated herein for all purposes by this reference.

### FIELD

The present disclosure relates to a method for manufacturing a bibim rice burger, more particularly, a method for manufacturing a bibim rice burger, including: a bun producing process; a sauce producing process; and a burger assembling process, for a bibim rice burger which replaces existing burger buns with bibim rice buns implemented in a bibimbap dish form, and in which lots of minor ingredients such as vegetables, eggs, and meat patty are mixed with hot pepper paste sauce.

### BACKGROUND

The hamburger is generally prepared by inserting patty formed of beef grilled or broiled, lettuce or tomato and the other vegetables between two pieces of bread, and is the most representative American food and fast-food beloved as a substitute for a meal. There are various kinds of hamburgers which have reflected various cultures of different countries.

In addition, because of the increased purchasing power of consumers and increased interest on healthy food, many consumers want favorite food having various forms. Against such backdrop, hamburger products which have been diversified in many ways including selection of ingredients and cooking methods appear. In order to satisfy various demands of consumers, various attempts are pursued such as replacing patty mostly made of beef with patty made of pork, chicken, lamb, fish, or soy meat, and using a new taste or an exotic sauce. In addition, various products using buns made of rice, barley, beans, tofu, or oriental medicine materials have been released.

However, unlike other ingredients such as patty, sauce, and vegetables, the buns are mostly made by using wheat flour as a main ingredient with some of minor ingredients added thereto, and when the buns are made by replacing all the wheat flour with other ingredient, the buns have no volume and the shape is imperfect. If the wheat flour is completely replaced, it will not be possible to get a positive response from consumers unless the characteristics of the main ingredient are preserved and differentiation is made in terms of appearance, texture, and taste compared to regular hamburger buns.

Recently, as K-food has emerged as a new food culture content through OTT, interest in Korean food has increased significantly both domestically and internationally, and attempts are being made to combine K-food with foreign food culture. Ultimately, it is necessary to launch the bibim rice burger, which will increase the use of our agricultural products and have a great effect on the globalization of K-food. Accordingly, there is a need for a bibim rice burger that can maintain the original form of bibim rice by mixing vegetables, eggs, and meat patties using hot pepper paste sauce and bibim rice buns that have the original taste and texture of rice grains and the form of bibimbap dish.

### PRIOR ART LITERATURE

### Patent Literature

Korea Patent No. 10-2004-0009504 (published on Jan. 31, 2004)

Korea Patent No. 10-2016-0064507 (published on Jun. 8, 2016)

Korea Patent No. 10-2023-0076147 (published on May 31, 2023)

### SUMMARY

An object of the present disclosure is to provide a method for manufacturing a bibim rice burger which replaces existing burger buns with rice buns, has a bibim rice shape, in which lots of minor ingredients such as vegetables having high content of moisture and seasonings are mixed, and is capable of maintaining an original shape of a bibimbap dish in which lots of minor ingredients such as vegetables, soft-cooked eggs, and meat patty are mixed with hot pepper paste sauce.

The objects of the present invention are not limited to those described above. The objects of the present invention will be clearly understood from the following description and could be implemented by means defined in the claims and a combination thereof.

One embodiment is a method for manufacturing a bibim rice burger, including: a bun producing process for producing a bibim rice bun; a hot pepper paste sauce producing process for producing a hot pepper paste sauce; and a burger producing process for assembling a bibim rice burger by comprising the hot pepper paste sauce and one or more selected from a group consisting of a meat patty, a soft-cooked egg, lettuce, and onions to the bibim rice bun and assembling the bibim rice burger.

The bun producing process may include a rice cooking stage for gelatinizing and cook rice, a stir-frying stage for stir-frying vegetables and seasonings, a mixing stage for mixing the cooked rice and the vegetables stir-fried in the stir-frying stage, a cooling stage for cooling the ingredients gone through the mixing stage, a forming stage for forming the ingredients gone through the cooling stage to take shape of rice buns; an oven cooking stage for heat treating the rice buns gone through the forming stage; and a freezing stage for freezing the rice buns gone through the oven cooking stage to retain a shape.

Pregelatinized waxy corn starch may be input in the stir-frying stage and the mixing stage, the ingredients may be vacuum cooled until a material temperature reaches 30 to 40° C.

in the cooling stage, and the ingredients may be heat treated by drying with hot air in a first trial and grilling in a second trial in the oven cooking stage.

In the rice cooking stage, rice including 40 to 60 wt.-% of non-glutinous rice, 5 to 10 wt.-% of glutinous rice, and 30 to 55 wt.-% of purified water based on 100 parts by weight may be cooked by gelatinizing the rice.

Non-glutinous rice may be soaked until a weight thereof becomes 1.1 to 1.5 times and glutinous rice may be soaked until a weight thereof becomes 1.15 to 1.55 times, and in the rice cooking stage, the rice may be cooked until a material temperature of gelatinized rice becomes 95° C. or more.

In the stir-frying stage, vegetables, seasonings, rapeseed oil and a pregelatinized waxy corn starch may be stir-fried, and the vegetables may include onions, carrots, green peppers, shiitake mushrooms and chives.

The seasonings may include hot pepper paste, mixed soybean sauce, sugar, garlic, corn syrup, beef concentrate, pork, beef dasida, and salt, and the hot pepper paste may include 11.0 to 17.0 wt.-% of the hot pepper paste based on 100 parts by weight of the bibim rice bun.

The pregelatinized waxy corn starch may be input into stir-fried vegetables when a material temperature of the stir-fried vegetables is at 60 to 70° C.

In the mixing stage, stir-fried vegetables stir-fried through a stir-frying stage, liquid condiments, and pregelatinized waxy corn starch may be mixed, and the liquid condiments may include salt, sugar, beef dasida, and a brewed soybean sauce.

1.0 to 3.0 wt.-% of the pregelatinized waxy corn starch may be mixed into the stir-fried vegetables into which liquid condiments are input and agitated.

In the cooling stage, cooling may be performed under a pressure of 0.39 to 0.69 Mpa at a temperature of 5 to 10° C.

In the first hot air processing, the bibim rice bun may be dried with hot air at a temperature of 150 to 290° C. for 1 to 5 minutes, and in the second grilling/heat treating, the bibim rice bun may be grilled in a grilling oven consisting of 8 to 14 gas stoves at a height of 50 to 110 mm for 1 to 5 minutes.

In the forming stage, the bibim rice bun may be formed to have a shape having a diameter of 60 to 120 mm, a height of 8 to 17 mm, and a weight of 75 to 115 g.

The sauce producing process may include: a first mixing stage for producing a first mixture by mixing one or more powdery ingredients selected from a group consisting of sugar, MSG, sesame seeds, red pepper powder, salt, black pepper, and xanthan gum, with purified water; a second mixing stage for producing a second mixture by adding one or more liquid ingredients selected from a group consisting of a hot pepper paste, refined rice wine and salted anchovy sauce to the first mixture; a heating stage for heating the second mixture; and a third mixing stage for producing a third mixture by adding modified starches or sesame seed oil to the heated second mixture.

In the heating stage, heating may be performed at a temperature of 90 to 100° C. for 20 to 30 minutes.

Another embodiment is a bibim rice burger produced according to the above-described method.

The method for manufacturing a bibim rice burger may provide a bibim rice burger of a new shape and concept by replacing the burger buns of the existing hamburger with bibim rice buns and making a bibimbap dish into a burger which wraps a hot pepper paste sauce, a meat patty, a soft-cooked egg, lettuce, and onions.

According to the present disclosure, it is possible to provide consumers with fun because the bibim rice burger having unique colors and a shape of the bibimbap dish differentiates itself from the existing hamburger in terms of the taste and external appearance.

According to the present disclosure, it is possible to provide the bibim rice burger which can differentiate itself from the existing hamburger, harmonize traditional taste of Korea with the western dishes, and facilitate a huge impact on the globalization of the Korean dishes.

In addition, the bibim rice burger according to the present disclosure may be more suitable for appetite of Koreans because the bibim rice burger uses rice and the hot pepper paste, and may provide consumers with visual satisfaction because the bibim rice burger maintains the form of the bibimbap dish.

It should be appreciated that the advantageous effects of the present disclosure are not limited to the effects described above, but encompass all effects that can be derived from the configurations of the present invention disclosed in the detailed description of the invention or the appended claims.

### BRIEF DESCRIPTION OF THE DRAWINGS

FIG. 1 is a picture of a bibim rice burger manufactured according to an embodiment of the present disclosure.

### DETAILED DESCRIPTION

Hereinafter, according to a method for manufacture according to the present disclosure, a method for manufacturing the bibim rice burger according to the present disclosure will be described in greater detail by each stage.

### 1. Bun Producing Process

This is a process for producing a bibim rice bun, and this process may reinforce the binding strength through divided putting of the suitable pregelatinized waxy corn starch, vacuum cooling, and an oven cooking process, and may make the bun maintain unique shape of the bibim rice bun by appropriately getting through gelatinization and retrogradation process by each stage. In addition, it is possible to provide the bibim rice bun which maintains its shape firmly and has differentiated colors and food texture by adjusting moisture of the outside of the bibim rice burger having a complete shape which has finished binding reactions through two oven cooking processes of the hot air and grilling process, and making the outside crispy.

Hereinafter, a bun producing process will be described in more detail by each stage.

### Rice Cooking Stage (S1)

In the rice cooking stage, the rice which is the main ingredient is gelatinized to prepare for production of the rice buns, and the rice includes the non-glutinous rice, the glutinous rice, and the like so as to reinforce the binding strength of the gelatinized rice.

When the gelatinization is conducted, it is preferable that the rice including 40 to 60 wt.-% of non-glutinous rice, 5 to 10 wt.-% of glutinous rice, and 30 to 55 wt.-% of purified water based on 100 parts by weight of one pot, is gelatinized.

The non-glutinous rice is soaked for 30 minutes or more until a weight thereof becomes about 1.1 to 1.5 times, and the glutinous rice is soaked for two hours or more until a weight thereof becomes about 1.15 to 1.55 times. When using the soaked rice, the heat flow becomes smooth when cooking rice, thereby preventing half-cooking, and reducing the time taken for gelatinization. When omitting the soaking process when cooking the rice, quality may be different per pot.

In the rice cooking stage, the rice is cooked until a material temperature of gelatinized rice becomes 95° C. or more, and it is preferable that a first rice cooking is conducted at a temperature of 250° C. or more for 20 to 40 minutes, and a second rice cooking is conducted at a temperature of 90° C. or more for 20 to 40 minutes.

### Stir-Frying Stage (S2)

The stir-frying stage is a stage for adjusting the moisture inside the vegetables which may be eluted when the cooked rice and vegetables are mixed, and for improving the binding strength of the cooked rice, vegetables, and seasonings by applying heat to the vegetables. The stir-frying stage uses stir-frying ingredients including vegetables, seasonings, rapeseed oil, and a pregelatinized waxy corn starch.

The vegetables have a rectangular shape of 5 to 7 mm or a slice shape of 3 to 7mm. The vegetables may include onions, carrots, green peppers, shiitake mushrooms and chives. The contents of each composition included in the vegetables may be 4.0 to 6.0 wt.-% of onions, 4.5 to 6.5 wt.-% of carrots, 2.0 to 4.0 wt.-% of green peppers, 1.3 to 3.3 wt.-% of shiitake mushrooms, and 1.0 to 3.0 wt.-% of chives.

The seasonings are materials for implementing the red color which reminds of the bibimbap dish in the bibim rice burger, and improving flavor of the processed food, and may include one selected from a group consisting of the hot pepper paste, mixed soybean sauce, sugar, garlic, corn syrup, beef concentrate, pork, beef dasida, and salt and the combination thereof. Preferably, the contents of each composition included in the seasoning may include 11.0 to 17.0 wt.-% of hot pepper paste, 0.5 to 1.5 wt.-% of salt, 0.2 to 0.8 wt.-% of soybean sauce, 0.3 to 0.9 wt.-% of sugar, 0.2 to 0.6 wt.-% of beef dasida, 0.1 to 0.2 wt.-% of garlic, 0.1 to 0.2 wt.-% of corn syrup, 0.1 to 0.2 wt.-% of beef concentrate, and 0.1 to 0.2 wt.-% of pork.

Preferably, 11.0 to 17.0 wt.-% of the hot pepper paste is mixed based on 100 parts by weight of the bibim rice buns. When the hot pepper paste is less than 11.0 wt.-% of the total weight, the unique red color of the bibimbap dish may not appear clearly in the finished product, and when the hot pepper paste exceeds 17.0 wt.-% of the total weight, all the main and minor ingredients thereof are hidden by the hot pepper paste, thereby adversely affecting the unique flavor and color and shape of the bibim rice burger.

It is preferable that 1.5 to 2.5 wt.-% of the rapeseed oil is mixed based on 100 parts by weight of the bibim rice buns. When the rapeseed oil is less than 1.5 wt.-% of the total weight, control of moisture in the vegetables may not be properly conducted due to lack of heat transfer inside the pot during the stir-frying stage, and when the rapeseed oil exceeds 2.5 wt.-% of the total weight, the flavor, color and shape of the vegetables and seasonings may become undesirable and binding of the main and minor ingredients may become difficult in the forming stage because lack of moisture adversely affects reaction of the pregelatinized waxy corn starch.

The pregelatinized waxy corn starch is white, has fine particles, and has high elasticity and viscosity, and requires high temperature in the gelatinization, therefore, the pregelatinized waxy corn starch is stable to heat and has strong binding capacity. In the stir-frying stage, when the pregelatinized waxy corn starch of less than 0.5 wt.-% of the total weight is mixed, the binding capacity is weakened because of improper control of moisture of the seasonings. When the pregelatinized waxy corn starch exceeding 2.5 wt.-% of the total weight is mixed, the starch absorbs all the moisture eluted from the vegetables and strong binding capacity is generated between the vegetables and seasonings in the stir-frying stage conducted at a high temperature, thereby causing difficulties in mixing the main and minor ingredients in the second mixing stage.

The stir-frying stage is preferably conducted in the order of the rapeseed oil, onions, carrots, green peppers, shiitake mushrooms, seasonings, beef dasida, salt, and chives, the stir-frying stage is performed for 12 to 18 minutes until the material temperature reaches 70° C. or more, and after the material temperature reaches 70° C. or more, the gas stove is turned off and 1.0 to 2.0 wt.-% of the pregelatinized waxy corn starch is input when the material temperature is less than 70° C.

When inputting the pregelatinized waxy corn starch when the material temperature is 70° C. or more, the ingredients may bind with each other upon inputting the pregelatinized waxy corn starch because the pregelatinized waxy corn starch reacts strongly and cannot spread out, thereby causing adverse effect not only on the mixing stage and forming stage, but also on the finished product because the pregelatinized waxy corn starch cannot permeate the vegetables and seasonings evenly.

### First Mixing Stage (S3)

In the first mixing stage, stir-fried vegetables, liquid condiments and the pregelatinized waxy corn starch are mixed. The liquid condiments are materials for improving the flavor of the processed food, and may include 0.5 to 1.5 wt.-% of salt, 0.1 to 0.5 wt.-% of sugar, 0.1 to 0.5 wt/-% of beef dasida, and 0.1 to 0.3 wt.-% of the brewed soybean sauce.

It is preferable that 1.0 to 3.0 wt.-% of the pregelatinized waxy corn starch is mixed into the stir-fried vegetables into which the liquid condiments are agitated.

### Second Mixing Stage (S4)

In the second mixing stage, the cooked rice and stir-fried vegetables prepared for the first mixing stage are mixed. The mixing is conducted under the condition of 50 to 70 rpm in the mixing speed for 35 seconds or less in a first mixing, and for 40 seconds or less in a second mixing.

The mixing is performed by moving the ingredients to separate mixers per stage. When mixing the ingredients all at once without dividing the number of times of mixing into first and second trials, seasonings may be biased on one side and when the time taken in mixing is 1 minute or more, the grains of the cooked rice may be mashed, leading to decreased commercial value of the finished product.

### Cooling Stage (S5)

In the cooling stage, the mixed rice is vacuum cooled for 10 minutes or less until a material temperature of the cooked rice mixed under a pressure of 0.39 to 0.69 Mpa at a temperature of 5 to 10° C. changes into 30 to 40° C.

The cooling process through the vacuum cooling has effects of reducing heat at the center of the mixed rice for a short period of time, removing humidity and heat on the inside and the outside of the cooked rice through vacuuming, and evenly spreading the stir-fried vegetables, liquid condiments, and the pregelatinized waxy corn starch.

The cooling is conducted preferably for 10minutes or less until the material temperature becomes 30 to 40° C. When the material temperature falls to less than 30° C., the binding strength of the pregelatinized waxy corn starch weakens, thereby the grains of the cooked rice may scatter or be broken when preparing the finished product. On contrary, when the material temperature exceeds 40° C. or more, the commercial value may decrease because the watery and sticky state poses overload to the apparatus in the forming stage and a shape having a commercial value is not formed.

Through the vacuum cooling, it is possible to make a unique shape of the rice buns by achieving a material temperature suitable for the forming and improvement on the binding reaction to ensure even mix of the stir-fried vegetables, which have reinforced binding strength, and the cooked rice, and smooth production. Therefore, it is possible to provide consumers with a product satisfying preference of the consumers.

### Forming Stage (S6)

In the forming stage, a diameter, a height, and a weight are suitably formed so as to ensure the rice buns to take its unique shape, and the rice buns may be preferably formed to take a shape having a diameter of 60 to 120 mm, a height of 8 to 17 mm, and a weight of 75 to 115 g.

### First Oven Cooking Stage (S7)

In the first oven cooking stage, drying the bibim rice buns in the hot air oven at 150 to 290° C. for 1 to 5 minutes is performed, and moisture of the bibim rice buns taken form can be removed through this stage. Moreover, through this stage, it is possible to further improve the binding strength which has been reinforced through the above-described cooling stage.

### Second Oven Cooking Stage (S8)

In the second oven cooking stage, the outer surface of the bibim rice buns produced through the first oven cooking stage, which is a hot air drying, and of which the binding strength is reinforced is grilled until golden, and thus, the unique shape of the rice buns can be maintained, and crispy texture can be created, thereby being able to further satisfy the preference of the consumers.

The second oven cooking stage may be conducted with a grilling oven, and preferably, the bibim rice buns may be grilled in the grilling oven consisting of 8 to 14 gas stoves at a height of 50 to 110 mm for 1 to 5 minutes.

The bibim rice buns according to the present disclosure which has been produced through the above-described stages can maintain its shape for longer period of time through the second cooking to the dining, and has soft and moist inside and crispy outside formed through the hot air drying and grilling oven stages.

The weight of the produced bibim rice buns may be 80 to 100 g, but is not necessarily limited thereto.

### 2. Sauce Producing Process

### First Mixing Stage

In the first mixing stage, one or more powdery ingredients selected from a group consisting of sugar, MSG, sesame seeds, red pepper powder, salt, black pepper, and xanthan gum are mixed with purified water so as to produce a first mixture. At this instance, the mixing condition is preferably mixing at 50 to 70 rpm in the mixing speed for 10 to 20 minutes.

The powdery ingredients may preferably include 5.0 to 15.0 wt.-% of sugar, 0.35 to 2.35 wt.-% of MSG, 0.5 to 1.5 wt.-% of sesame seeds, 0.5 to 1.5 wt.-% of red pepper powder, 0.5 to 1.5 wt.-% of salt, 0.1 to 0.3 wt.-% of black pepper, and 0.02 to 0.08 wt.-% of xanthan gum.

### Second Mixing Stage

In the second mixing stage, one or more liquid ingredients selected from a group consisting of a hot pepper paste, refined rice wine and salted anchovy sauce are added to the first mixture so as to produce a second mixture. The mixing condition is preferably mixing at 20 to 60 rpm in the mixing speed for 20 to 30 minutes.

The liquid ingredients may include 15.0 to 25.0 wt.-% of the hot pepper paste, 5.0 to 9.0 wt.-% of the refined rice wine, and 0.5 to 1.5 wt.-% of the salted anchovy sauce.

### Heating Stage

In the heating stage, the mixture is heated at 90 to 100° C. for 20 to 30 minutes.

It is possible to provide a product which satisfies the preference of the consumers because unique color and shape, and flavor of the sautéed hot pepper paste, and complete mixing of the powdery ingredients and the liquid ingredients are obtained through the heating stage.

### Third Mixing Stage

In the third mixing stage, modified starches or sesame seed oil is added to the heated second mixture so as to produce a third mixture. The mixing condition is mixing at 10 to 50 rpm in the mixing speed for 10 to 20 minutes.

In more detail, the third mixture may include 1.0 to 5.0 wt.-% of the modified starches which is acetylated distarch adipate, and 2.0 to 8.0 wt.-% of the sesame seed oil.

### 3. Burger Producing Process

In the burger producing process, the hot pepper paste sauce and one or more selected from a group consisting of a meat patty, a soft-cooked egg, lettuce, onions, and the combination thereof may be added to the bibim rice buns.

The burger producing process may include 45.0 to 65.0 wt.-% of the bibim rice buns, 10.0 to 20.0 wt.-% of the meat patty, 10.0 to 20.0 wt.-% of the soft-cooked egg, 2.5 to 7.5 wt.-% of lettuce, 1.5 to 5.5 wt.-% of the hot pepper paste sauce, and 1.0 to 3.0 wt.-% of the onions.

According to the present disclosure, it is possible to produce a bibim rice burger which replaced existing burger buns with bibim rice buns, and which has a new shape and concept as a bibim rice burger.

Hereinafter, the present disclosure will be descried in in greater detail through the embodiments. However, the embodiments are taken example of the present disclosure, and the present disclosure is not limited by these embodiments.

### Embodiment

The preferable embodiment of the present disclosure consists of a bun producing process, a sauce producing process, and a burger producing process as below.

### 1. Bun Producing Process

### Embodiment 1

In order to cook the rice, 50.0 wt.-% of non-glutinous rice, 8.0 wt.-% of glutinous rice, and 42.0 wt.-% of purified water based on 100 parts by weight of one pot are prepared. Rice cooking is conducted until the material temperature reaches 95° C. or more, and the first cooking is conducted at a temperature of 290° C. or more for 30 minutes, and the second cooking is conducted at a temperature of 95° C. or more for 30 minutes. As the stir-frying ingredients which are minor ingredients, vegetables (5.0 wt.-% of onions having a rectangular shape of 5 mm, 5.5 wt.-% of carrots having a rectangular shape of 5 mm, 3.0 wt.-% of green peppers having a rectangular shape of 5 mm, 2.3 wt.-% of shiitake mushrooms having a rectangular shape of 10 mm, and 2 wt.-% of chives having a slice shape of 3 mm), seasonings (14.0 wt.-% of the hot pepper paste, 1.0 wt.-% of salt, 0.5 wt.-% of soybean sauce, 0.6 wt.-% of sugar, 0.4 wt.-% of beef dasida, 0.15 wt.-% of garlic, 0.15 wt.-% of corn syrup, 0.15 wt.-% of beef concentrate, and 0.15 wt.-% of pork), 2 wt.-% of the rapeseed oil, and 1.5 wt.-% of the pregelatinized waxy corn starch are configured, and stir-frying is conducted in the order of stir-frying the rapeseed oil, onions, carrots, green peppers, shiitake mushrooms, seasonings, beef dasida, salt, and chives, for 15 minutes until the material temperature reaches 70° C. or more. When the material temperature reaches 70° C., the gas stove is turned off and the pregelatinized waxy corn starch is input when the material temperature is less than 70° C. After mixing the liquid condiments (1.0 wt.-% of salt, 0.3 wt.-% of sugar, 0.3 wt.-% of beef dasida, and 0.2 wt.-% of a brewed soybean sauce) into the stir-fried vegetables which have finished stir-frying, the pregelatinized waxy corn starch is added into the mixture additionally. Main and minor ingredients which have finished the preparation, which are 60 wt.-% of cooked rice and 40 wt.-% of the stir-fried vegetables, which have reinforced the biding strength, are mixed, by two separate times, at 60 rpm in the mixing speed for 30 seconds in a first trial, and for 17 seconds in a second trial. The mixed main and minor ingredients are vacuum cooled under a pressure of 0.5 Mpa at a temperature of 7° C. for 10 minutes until the material temperature reaches 35° C. The rice buns, which have finished the cooling, are formed to take a shape having a diameter of 90 mm, a height of 13 mm, and a weight of 95 g. For three times, the bibim rice buns, which have finished the forming, are dried by hot air at a temperature of 220° C. for 2minutes and are grilled for 2 minutes with 11 gas stoves at a height of 80 mm. The completed bibim rice buns are frozen at a temperature of 38° C. below zero for 30 minutes and cooked for 60 seconds in a micro-oven of 1700 W as the secondary cooking.

### Comparative Embodiments 1 to 2

The food is processed through the same processes as the Embodiment 1, however, in the Comparative Embodiments 1 to 2, the food is cooled to have a material temperature of 10° C. and 60° C. after the cooling.

### Experimental Embodiment 1: Comparative Evaluation of the Binding Strength According to a Material Temperature After Cooling

In the Embodiment 1 and Comparative Embodiments 1 to 2, the commercial values of forming and the binding strength of the bibim rice buns which have finished the secondary cooking are evaluated according to the material temperature after cooling.

Regarding the commercial value of forming, the output for 1hour and the forming inferiority rate are measured. Regarding the method of measuring the binding strength, the buns are cooked for 60 seconds in the micro-oven of 1700 W in the secondary cooking and waited for 30 seconds, and whether the buns placed on the measuring plate maintain the shape for 10 seconds is measured. The table 1 below shows the average value by measuring 5 of each sample.

TABLE 1

| | | Comparative | Comparative |
|---|---|---|---|
| Classification | Embodiment 1 | Embodiment 1 | Embodiment 2 |
| Output (ea) | 8000 | 8000 | 6000 |
| inferiority | 1 | 1 | 10 |
| rate (%) | | | |
| Binding | 10 | 4 | 6 |
| strength | | | |
| (seconds) | | | |

According to the result of Table 1, there are differences in the binding strength after the secondary cooking of the finished product is performed, and in case the material temperature before the forming is 10° C. as in the Comparative Embodiment 1, the time for which the rice buns maintain the unique shape appears to be 4 seconds or less after the secondary cooking. Thus, dramatic decline of the binding strength is seen.

In addition, as in the Comparative Embodiment 2, in case the material temperature before forming is 40° C., the binding strength of the finished product is poor as well, and difficulties in increasing the production rate occur because the product sticks to the molder because of high binding strength and a hot temperature when the forming is performed, causing overload to the apparatus.

In case of the Embodiment 1, it is seen that the material temperature control before the forming is important in consideration of the production rate per 1hour, inferior rate, and the binding strength.

### Comparative Embodiment 3

The food is processed through the same processes as the Embodiment 1, however, in the Comparative Embodiment 3, the input temperature when inputting the pregelatinized waxy corn starch is controlled to be at 100° C. in the stir-frying stage of the vegetables.

### Comparative Embodiment 4

The food is processed through the same processes as the Embodiment 1, however, in the Comparative Embodiment 4, the pregelatinized waxy corn starch is not input in the manner of divisional input per stage in the stir-frying stage of the vegetables, but the whole amount thereof is input at once in the first mixing stage.

### Comparative Embodiment 5

The food is processed through the same processes as the Embodiment 1, however, in the Comparative Embodiment 5, the pregelatinized waxy corn starch is not input at all.

### Experimental Embodiment 2: Comparative Evaluation of the Binding Strength, External Appearance, and Chromaticity According to the Input Temperature of the Pregelatinized Waxy Corn Starch and the Order

In the Embodiment 1 and Comparative Embodiments 3 to 5, the binding strength of the bibim rice buns which have finished the secondary cooking is evaluated in terms of the input temperature of the pregelatinized waxy corn starch and the order. The picture of the external appearance is captured after visual inspection before conducting the secondary cooking, and chromaticity is measured using a color difference meter on the outside. The method for measuring the binding strength includes performing the secondary cooking for 60 seconds in the micro-oven of 1700 W for 60 seconds, waiting for 30 seconds, placing the food on the measuring plate, and measuring whether the food maintains its shape for 10 seconds. The table 2 below shows the average value by measuring 5 of each sample.

According to the result shown in Table 2, the binding strength is measured 5 seconds and 1 second in the Comparative Embodiments 4 and 5, respectively, which are relatively low compared to the Embodiment 1 and the Comparative Embodiment 3. Therefore, the commercial value is low. When looking into the external appearance, in case of the Comparative Embodiments 4 and 5, cracked appearance is seen even before the secondary cooking is performed, and in case of the Comparative Embodiment 3, the pregelatinized waxy corn starch is mixed with the grains in a state in which the pregelatinized waxy corn starch is not spread out and binding together at a high temperature. When comparing the chromaticity (value L: brightness, value a: red↔green, value b: yellow↔blue, value ΔE: total chrominance value), in the Comparative Embodiments 4 and 5, all values L, a, and b appear to be relatively low compared to the Embodiment 1 and the Comparative Embodiment 3. Therefore, the results are different from one another to the human eye and in terms of numerical values. In addition, in the total chrominance values, differences are measured compared to the Embodiment 1, which is the reference. The total chrominance values are classified into 5 levels, including 1 or less than 1 (impossible to be recognized to the human eye), 1 to 2 (possible to be recognized through meticulous observation), 2 to 10 (possible to be recognized at a look), 11 to 49 (opposite color), and 50 to 100 (completely opposite color). The Comparative Embodiment 4 showed a similar color to a color of the Embodiment 1 and has a gap of 1.93, and the Comparative Embodiments 4 and 5 have gaps of 5.09 and 6.08, respectively, compared to the Embodiment 1, showing differences.

There are differences in the quality according to the order of inputting the pregelatinized waxy corn starch and the temperature. When the material temperature reaches 70° C. when stir-frying the vegetables, the gas stove is turned off and after the material temperature is less than 70° C., 1.5 wt.-% of the pregelatinized waxy corn starch is input. Then, the liquid condiments are mixed into the stir-fried vegetables which have finished stir-frying, and then, the 2.0 wt.-% of the pregelatinized waxy corn starch is input additionally to the stir-fried vegetables. In such a case, the binding strength is maintained for 10 seconds which is good, and cracking or binding together is not seen in the external appearance.

With this observation, it can be seen that the Embodiment 1 supports characteristics of the bibimbap dish, and shows that the grains cooked according to the Embodiment 1 retain the original shape throughout all stages of transfer, storage, the secondary cooking, and the assembly, therefore, the Embodiment 1 is shown to be very effective in making the bibim rice buns be capable of retaining the unique shape.

### Embodiments 2 to 3

The food is processed through the same processes as the Embodiment 1, however, in the Embodiments 2 to 3, the number of times for conducting the hot air drying in the hot air oven cooking process is controlled to be 1 time and 2 times, respectively.

### Comparative Embodiment 6

The food is processed through the same processes as the Embodiment 1, however, the hot air oven cooking process is not included in the oven cooking process.

### Comparative Embodiment 7

The food is processed through the same processes as the Embodiment 1; however, the grilling oven cooking process is not included in the oven cooking process.

### Comparative Embodiment 8

The food is processed through the same processes as the Embodiment 1; however, all the oven cooking processes are omitted.

### Experimental Embodiment 3: Comparative Evaluation of Properties, Contents of Moisture, and Binding Strength Per Oven Cooking Process

Properties, contents of moisture, and binding strength of the bibim rice buns completed according to the oven cooking process in the Embodiments 1 and Embodiments 2 to 3, and the Comparative Embodiments 6 to 8 are evaluated. The method for measuring the moisture content includes tearing off a center portion of the completed bibim rice buns and measuring moisture content thereof at 105° C. for 60 seconds using the infrared moisture measuring instrument. The method for measuring the binding strength includes cooking the food in the micro-oven of 1700 W for 60 seconds as the secondary cooking, waiting for 30 seconds, placing the food on the measuring plate, and measuring whether the food maintains the shape for 10 seconds. The method for measuring the properties (hardness) includes measuring a center portion of the bibim rice buns cooked in the secondary cooking using the texture analyzer. The Table 3 below shows the average value by measuring 5 of each sample.

TABLE 3

| | Embodiment | Embodiment | Embodiment | Comparative | Comparative | Comparative |
|---|---|---|---|---|---|---|
| classification | 1 | 2 | 3 | Embodiment 6 | Embodiment 7 | Embodiment 8 |
| Binding | 10 | 7 | 8 | 3 | 4 | 1 |
| strength | | | | | | |
| (seconds) | | | | | | |
| hardness(g) | 2568 | 2012 | 2134 | 1680 | 1888 | 1358 |
| moisture | 43.71 | 45.88 | 47.90 | 50.46 | 51.87 | 55.58 |
| content (%) | | | | | | |

According to the result shown in Table 3, the binding strength is measured 10 seconds in the Embodiment 1, which is relatively high compared to the Embodiments 2 to 3 and the Comparative Embodiments 6 to 8. This shows that a binding strength suitable for the bibim rice buns product is obtained when the total oven cooking process is performed for at least 4 minutes or more. In terms of the hardness, it is seen that the hardness of the Embodiment 1 is 2568, and the hardness values of Embodiments 2 to 3, and the Comparative Embodiments 6 to 7 are low. This verifies that the grilling oven cooking process bakes the outside of the bibim rice buns until golden and influences crispy texture of food. In terms of the content of moisture, the measured values of the Comparative Embodiments 6, 7, and 8, which have omitted the oven cooking process, are 50.46%, 51.87% and 55.58%, respectively, which are relatively high, verifying that the total oven cooking process must be performed for at least 4 minutes so as to obtain a content of moisture suitable for the bibim rice buns.

It is seen that moistness on the inside and crispiness on the outside are obtained through two-staged oven cooking process, divided into the hot air oven cooking process, and the grilling oven cooking process.

### Experimental Embodiment 4: Test for Identifying the Texture of Food According to the Oven Cooking Process

A test is performed for identifying difference in the texture of food of the finished product cooked according to the Embodiment 1. The test is performed with the Embodiment 1 and the Comparative Embodiment 8, and for the test, the samples were provided in the order of AA, AB, BA, and BB, which are pairs of the identical samples or non-identical samples. 60 trained people conducted the test, and Table 4 below shows the tested values for each sample.

TABLE 4

| Pairs of | Response frequency | |
|---|---|---|
| sample | identical | non-identical |
| AA | 68 | 2 |
| AB | 1 | 59 |
| BA | 0 | 60 |
| BB | 56 | 4 |
| Total | 125 | 125 |

According to the result of Table 4, in identical pairs, many responded that the texture of food is identical, and in non-identical pairs, many responded that the texture of food is non-identical. It is seen that there is a significant difference in the texture of food between the two samples, Embodiment 1 and Comparative Embodiment 8.

### Experimental Embodiment 5: Preference Test on the External Appearance and the Texture of Food Per Oven Cooking Process

A preference test is performed on appearance (color) and texture (crispiness and moistness) of the finished product cooked according to the Embodiment 1. The test was conducted using a 9-point scale, and one finished product was provided for each sample. 60 trained people performed the test, and Table 5 below shows the values tested for each sample.

TABLE 5

| | | | Comparative | Comparative | Comparative |
|---|---|---|---|---|---|
| Test item | | Embodiment 1 | Embodiment 3 | Embodiment 6 | Embodiment 8 |
| Appearance (color) | | 8.7 | 7.5 | 6.8 | 6.7 |
| texture | Crispiness | 8.4 | 6.7 | 8.1 | 5.4 |
| | (outside) | | | | |
| | Moistness | 7.9 | 6.4 | 6.7 | 7.2 |
| | (inside) | | | | |

| | | | | |
|---|---|---|---|---|
| overall preference | 8.6 | 6.9 | 7.1 | 6.4 |

According to the result of Table 5, the Embodiment 1, which has conducted the hot air oven cooking and grilling oven cooking processes one after another, gets higher scores in the overall sensory evaluation than the Comparative Embodiment 3 which has conducted the hot air oven cooking process only, the Comparative Embodiment 2 which has conducted the grilling oven cooking process only, and the Comparative Embodiment 8 which has omitted the oven cooking process. The result has shown that use of the hot air oven cooking and the grilling oven cooking gives positive impact on the finished product of the bibim rice buns in maintaining its shape and having moist food texture. In addition, use of the grilling oven cooking has positive impact on the crispiness on the outside. It is seen that the Embodiment 1 gets the highest score in the overall sensory evaluation regarding the appearance, food texture, and the overall preference.

### Comparative Embodiment 9 to 10

The food is processed through the same processes as the Embodiment 1; however, the amount of the hot pepper paste to be mixed into the vegetables in the stir-frying stage of the Comparative Embodiments 9 to 10 is adjusted to 10.0 wt.-% and 18 wt.-% based on 100 parts by weight of the bibim rice buns, respectively.

### Experimental Embodiment 6: Preference Test on the External Appearance and Flavor Per Input Amount of the Hot Pepper Paste

A preference test is performed on appearance (color) and flavor of the finished product cooked according to the Embodiment 1. The test was conducted using a 9-point scale, and one finished product was provided for each sample. 60 trained people performed the test, and Table 6 below shows the values tested for each sample.

According to the result of Table 6, the Embodiment 1 which has mixed 14.0 wt.-% of the hot pepper paste gets higher scores in the overall sensory evaluation than the Comparative Embodiment 9 which has mixed 10.0 wt.-% of the hot pepper paste and Comparative Embodiment 10 which has mixed 18.0 wt.-% of the hot pepper paste. This has shown that the amount of input of the hot pepper paste influences the color of the appearance and the flavor. Input of 14.0 wt.-% of the hot pepper paste has positive impact on the finished product of the bibim rice buns. It is verified that the Embodiment 1 gets the highest scores in the overall sensory evaluation regarding the appearance, the flavor, and the overall preference.

### 2. A Sauce Producing Process

In order to produce the hot pepper paste sauce, 49.4 wt.-% of purified water, powdery ingredients (10 wt.-% of sugar, 1.35 wt.-% of MSG, 1.0 wt.-% of sesame seeds, 1.0 wt.-% of red pepper powder, 1.0 wt.-% of salt, 0.2 wt.-% of black pepper, and 0.05 wt.-% of xanthan gum), liquid ingredients (20.0 wt.-% of the hot pepper paste, 7.0 wt.-% of refined rice wine, and 1.0 wt.-% of salted anchovy sauce), 3.0 wt.-% of acetylated distarch adipate, and 5.0 wt.-% of sesame seed oil are mixed and heated.

### 3. A Burger Producing Process

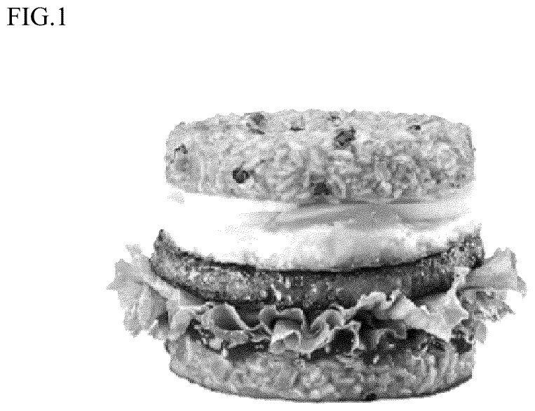

In order to assemble the bibim rice burger, 15.0 wt.-% of meat patty, 15.0 wt.-% of the soft-cooked egg, 5.5 wt.-% of lettuce, 3.5 wt.-% of the hot pepper paste, 2.0 wt.-% of onions, and 59.0 wt.-% of the bibim rice buns according to the Embodiment 1 are configured and combined with one another, and the image thereof is FIG. 1.

Example embodiments have been described more fully with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

What is claimed is:

1. A method for manufacturing a bibim rice burger, comprising:
a bun producing process for producing a bibim rice bun;
a hot pepper paste sauce producing process for producing a hot pepper paste sauce;
a burger producing process for assembling a bibim rice burger by comprising the hot pepper paste sauce and one or more selected from a group consisting of a meat patty, a soft-cooked egg, lettuce, and onions to the bibim rice bun and assembling the bibim rice burger
wherein the bun producing process comprises,
a rice cooking stage for gelatinizing and cooking rice;
a stir-frying stage for stir-frying vegetables and seasonings;
a mixing stage for mixing the cooked rice and the vegetables stir-fried in the stir-frying stage;
a cooling stage for cooling the ingredients mixed in the mixing stage;
a forming stage for forming the ingredients cooled in the cooling stage to take shape of rice buns;
an oven cooking stage for heat treating the rice buns formed to take shape in the forming stage; and
a freezing stage for freezing the rice buns oven cooked in the oven cooking stage to retain a shape,
wherein pregelatinized waxy corn starch is input in the stir-frying stage and the mixing stage, the ingredients mixed in the mixing stage are vacuum cooled until a material temperature reaches 30 to 40° C. in the cooling stage, and the ingredients are heat treated by drying with hot air in a first trial and grilling in a second trial in the oven cooking stage.

2. The method of claim 1, wherein in the rice cooking stage, rice comprising 40 to 60 wt.-% of non-glutinous rice, 5 to 10 wt.-% of glutinous rice, and 30 to 55 wt.-% of purified water based on 100 parts by weight is cooked by gelatinizing the rice.

3. The method of claim 2, wherein non-glutinous rice is soaked until a weight thereof becomes 1.1 to 1.5 times and glutinous rice is soaked until a weight thereof becomes 1.15 to 1.55 times.

4. The method of claim 1, wherein in the rice cooking stage, the rice is cooked until a material temperature of gelatinized rice becomes 95° C. or more.

5. The method of claim 1, wherein in the stir-frying stage, vegetables, seasonings, rapeseed oil and a pregelatinized waxy corn starch are stir-fried.

6. The method of claim 5, wherein the vegetables comprise onions, carrots, green peppers, shiitake mushrooms and chives.

7. The method of claim 5,
wherein the seasonings comprise hot pepper paste, mixed soybean sauce, sugar, garlic, corn syrup, beef concentrate, pork, beef dasida, and salt, and
wherein the hot pepper paste comprises 11.0 to 17.0 wt.-% of the hot pepper paste based on 100 parts by weight of the bibim rice bun.

8. The method of claim 5, wherein the pregelatinized waxy corn starch is input into stir-fried vegetables when a material temperature of the stir-fried vegetables is at 60 to 70° C.

9. The method of claim 1, wherein in the mixing stage, stir-fried vegetables stir-fried through a stir-frying stage, liquid condiments, and pregelatinized waxy corn starch are mixed.

10. The method of claim 9, wherein the liquid condiments comprise salt, sugar, beef dasida, and a brewed soybean sauce.

11. The method of claim 9, wherein 1.0 to 3.0 wt.-% of the pregelatinized waxy corn starch is mixed into the stir-fried vegetables into which liquid condiments are input and agitated.

12. The method of claim 1, wherein in the cooling stage, cooling is performed under a pressure of 0.39 to 0.69 Mpa at a temperature of 5 to 10° C.

13. The method of claim 1, wherein in the first hot air processing, the bibim rice bun is dried with hot air at a temperature of 150 to 290° C. for 1 to 5 minutes.

14. The method of claim 1, wherein in the second grilling/heat treating, the bibim rice bun is grilled in a grilling oven consisting of 8 to 14 gas stoves at a height of 50 to 110 mm for 1 to 5 minutes.

15. The method of claim 1, wherein in the forming stage, the bibim rice bun is formed to have a shape having a diameter of 60 to 120 mm, a height of 8 to 17 mm, and a weight of 75 to 115 g.

16. The method of claim 1,
wherein the sauce producing process comprises:
a first mixing stage for producing a first mixture by mixing one or more powdery ingredients selected from a group consisting of sugar, MSG, sesame seeds, red pepper powder, salt, black pepper, and xanthan gum, with purified water;
a second mixing stage for producing a second mixture by adding one or more liquid ingredients selected from a group consisting of a hot pepper paste, refined rice wine and salted anchovy sauce to the first mixture;
a heating stage for heating the second mixture; and
a third mixing stage for producing a third mixture by adding modified starches or sesame seed oil to the heated second mixture.

17. The method of claim 16, wherein in the heating stage, heating is performed at a temperature of 90 to 100° C. for 20 to 30 minutes.

18. A bibim rice burger produced according to claim 1.
